(19) United States
(12) Patent Application Publication
(10) Pub. No.: US 2014/0028951 A1
(43) Pub. Date: Jan. 30, 2014

(54) LIQUID CRYSTAL DISPLAY DEVICE

(71) Applicant: Japan Display Inc., Tokyo (JP)

(72) Inventor: Akihiro WATANABE, Mobara (JP)

(73) Assignee: Japan Display Inc., Tokyo (JP)

(21) Appl. No.: 13/951,773

(22) Filed: Jul. 26, 2013

(30) Foreign Application Priority Data
Jul. 27, 2012 (JP) 2012-167619

(51) Int. Cl. G02F 1/1333

(52) U.S. Cl. CPC G02F 1/133308
USPC 349/58

(57) ABSTRACT

A liquid crystal display device is provided in which the warp of a liquid crystal display panel and the intrusion of a foreign material into a gap between the liquid crystal display panel and a backlight can be prevented. The liquid crystal display device includes a liquid crystal display panel including an image forming area where pixels are arranged and an image is formed, a backlight which is a flat light source, and a transparent support member which is disposed between the liquid crystal display panel and the backlight and is in surface contact with the liquid crystal display panel and the backlight over an entire area of the image forming area.

### CROSS-REFERENCE TO RELATED APPLICATION

The present application claims priority from Japanese application JP 2012-167619 filed on Jul. 27, 2012, the content of which is hereby incorporated by reference into this application.

### BACKGROUND OF THE INVENTION

1. Field of the Invention

The present invention relates to a liquid crystal display device.

2. Description of the Related Art

In a self-luminous liquid crystal display device including a backlight, as disclosed in JP 2007-206125A, a substantially rectangular liquid crystal display panel and a substantially rectangular backlight are fixed by attaching a double-sided tape along the outer periphery of each of them.

### SUMMARY OF THE INVENTION

In the structure as disclosed in JP 2007-296125A, a gap is formed between the liquid crystal display panel and the backlight by the thickness of the adhesive tape. Thus, uneven brightness may occur due to the warp of the liquid crystal display panel or the intrusion of a foreign material into the gap.

The invention is made in view of such circumstances, and an object thereof is to provide a liquid crystal display device in which the warp of a liquid crystal display panel and the intrusion of a foreign material into a gap between the liquid crystal display panel and a backlight can be prevented.

The outline of representative inventions disclosed in the present application will be briefly described below.

(1) A liquid crystal display device includes a liquid crystal display panel including an image forming area where pixels are arranged and an image is formed, a backlight which is a flat light source, and a transparent support member which is disposed between the liquid crystal display panel and the backlight and is in surface contact with the liquid crystal display panel and the backlight over an entire area of the image forming area.

(2) In the liquid crystal display device of (1), the transparent support member includes plural laminated plate-like members different in size.

(3) In the liquid crystal display device of (1), the transparent support member includes a step at an end.

(4) In the liquid crystal display device of any one of (1) to (3), the transparent support member is bonded to the liquid crystal display panel and the backlight.

(5) In the liquid crystal display device of any one of (1) to (4), an outer peripheral part of the transparent support member has a light-shielding property.

According to (1), the liquid crystal display device can be obtained in which the warp of the liquid crystal display panel and the intrusion of a foreign material into a gap between the liquid crystal display panel and the backlight can be prevented.

According to (2) or (3), when the backlight includes a convex part having a step at an outer periphery of the image forming area, the transparent support member is supported without rattling.

According to (4), a double-sided tape for bonding the liquid crystal display panel and the backlight is not required.

According to (5), a special structure for preventing light from leaking to the outer periphery of the image forming area is not required.

### BRIEF DESCRIPTION OF THE DRAWING

FIG. 1 is an exploded perspective view of a liquid crystal display device of a first embodiment of the invention.

FIG. 2 is a schematic sectional view of the liquid crystal display device along line II-II of FIG. 1.

FIG. 3 is an exploded perspective view of a liquid crystal display device of a second embodiment of the invention.

FIG. 4 is a schematic sectional view of the liquid crystal display device along line IV-IV of FIG. 3.

FIG. 5 is an exploded perspective view of a liquid crystal display device of a third embodiment of the invention.

FIG. 6 is a schematic sectional view of the liquid crystal display device along line VI-VI of FIG. 5.

FIG. 7 is an exploded perspective view of a liquid crystal display device of a fourth embodiment of the invention.

FIG. 8 is a schematic sectional view of the liquid crystal display device along line VIII-VIII of FIG. 7.

### DETAILED DESCRIPTION OF THE INVENTION

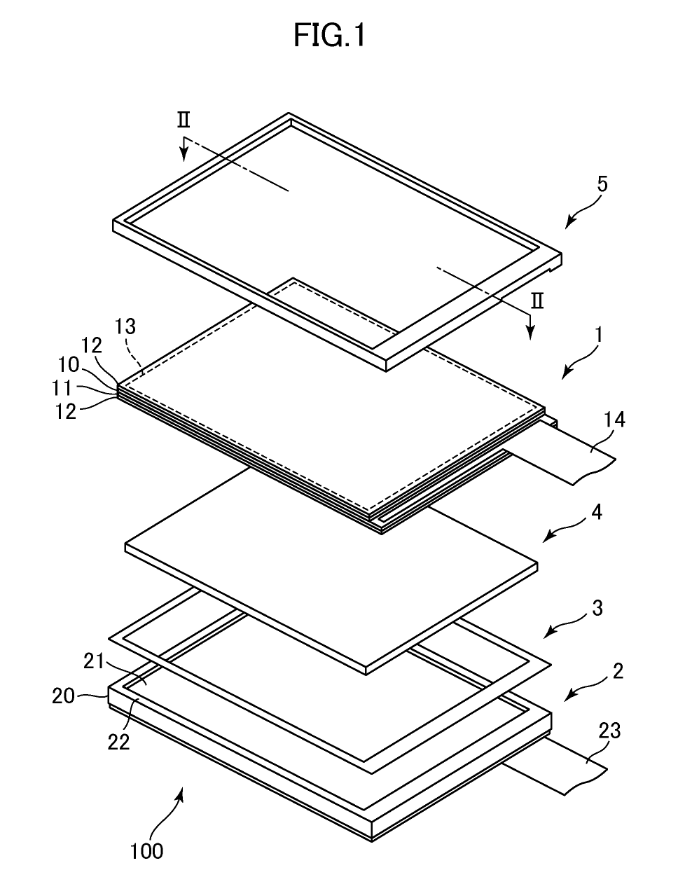

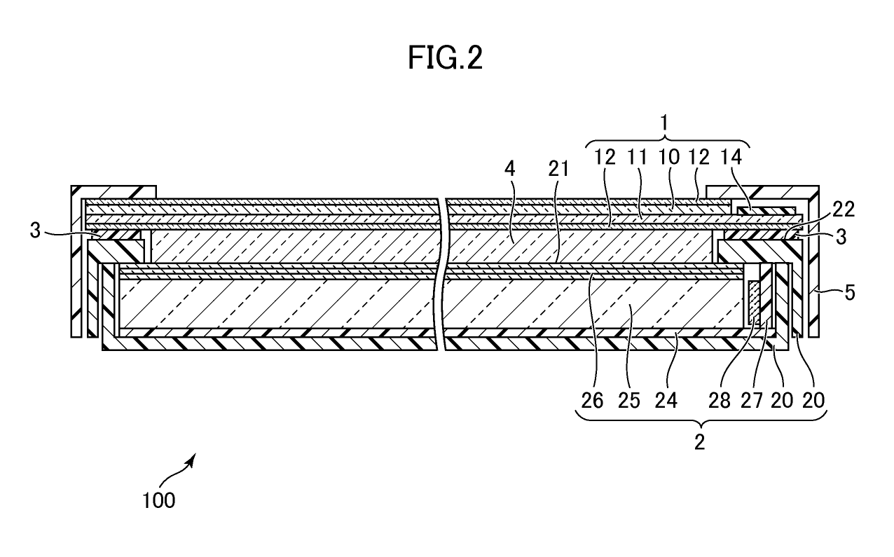

Hereinafter, a first embodiment of the invention will be described with reference to FIG. 1 and FIG. 2.

FIG. 1 is an exploded perspective view of a liquid crystal display device 100 of the first embodiment of the invention. The liquid crystal display device 100 has such a structure that a liquid crystal display panel 1 and a backlight 2 as a flat light source are bonded to each other by an adhesive member 3 such as a double-sided tape. Besides, a transparent support member 4 is disposed between the liquid crystal display panel 1 and the backlight 2. A frame 5 is attached to a front surface side of the liquid crystal display panel 1. Incidentally, in this specification, a surface on a side facing an observer who sees the liquid crystal display device 100 is called a front surface, and a surface opposite thereto is called a back surface. Besides, a direction toward the observer is called a front surface side, and a direction opposite thereto is called a back surface side.

The liquid crystal display panel 1 is a common transmissive liquid crystal display panel and has such a structure that liquid crystal is sandwiched between a first substrate 10 called a color filter substrate and a second substrate 11 called a TFT substrate.

Pixel electrodes as electrodes corresponding to many pixels regularly arranged in lattice form are formed on a surface of the second substrate 11, and a TFT (Thin Film Transistor) is connected to each of the pixel electrodes. The ON-OFF of the TFT is controlled, and a voltage corresponding to an image to be displayed is applied to each of the pixel electrodes, so that a desired electric field passing through the liquid crystal is generated, and the orientation direction of the liquid crystal is controlled. The polarization direction of a light beam passing through the liquid crystal layer having the specific orientation is changed. A polarization plate 12 is bonded to each of a front surface of the first substrate 10 and a back surface of the second substrate 11, and allows the light beam having the specific polarization direction to pass through. By this structure, the transmittance of the light beam passing through each of the pixels is controlled by the voltage applied to each of the pixel electrodes, and an image is formed. Accordingly, in an area occupied by the liquid crystal display panel 1, an area where the pixels are formed is an image forming area 13 where an image is formed. In the drawing, the image forming area 13 is a rectangular area indicated by a broken line. Besides, a front surface of one side of the second substrate 11 is exposed, and an FPC (Flexible Printed Circuits) 14 for electrical connection to an external equipment is connected.

Incidentally, although the driving system of the liquid crystal display panel 1 of the liquid crystal display device 100 of this embodiment is an IPS (In Plane Switching) system, no limitation is made to the system, and any well-known system may be used. For example, a TN (Twisted Nematic) system or a VA (Vertical Alignment) system may be used.

The backlight 2 is a flat light source for uniformly illuminating the whole surface of the image forming area 13. The backlight 2 includes a backlight case 20 for housing various members constituting the backlight 2, and a light-emitting surface 21 which is positioned in an opening of a front surface of the backlight case 20 and the size and shape of which are equal to or slightly larger than those of the image forming area 13. As shown in the drawing, since the light-emitting surface 21 is at a position lower than the front surface of the backlight case 20 by one step toward the back surface side, the front surface of the backlight case 20 is a convex part 22 surrounding the outer periphery of the image forming area 13 and protruding toward the front surface side.

The light source of the backlight 2 and the type thereof are not particularly limited but may be arbitrary. For example, a CCFL (Cold Cathode Fluorescent Lamp), an LED (Light-Emitting Diode) or an EL (Electro Luminescence) illumination may be used as the light source. An FPC 23 for electric connection to the external equipment extends from the back surface of the backlight 2.

The adhesive member 3 is a black or deep color double-sided tape having a rectangular frame shape, and bonds the front surface of the convex part 22 of the backlight case 20 to the back surface outer peripheral part of the liquid crystal display panel 1, so that the liquid crystal display panel 1 and the backlight 2 are fixed to each other. The adhesive member 3 has the black or deep color in order to prevent a light beam from the backlight 2 from leaking to the outside of the image forming area 13.

The transparent support member 4 is a plate which is transparent and the shape and size of which are equal to or slightly larger than those of the image forming area 13. The flat shape thereof has such a size that the support member is fitted in the opening of the front surface of the backlight case 20. Besides, the thickness of the transparent support member 4 is selected so that when the liquid crystal display panel 1 and the backlight 2 are bonded and fixed by the adhesive member 3, the front surface of the transparent support member 4 is in surface contact with the back surface of the image forming area 13 of the liquid crystal display panel 1 over the whole area, and the back surface of the transparent support member 4 is in surface contact with the front surface of the light-emitting surface 21 of the backlight 2. Accordingly, the transparent support member 4 is filled between the back surface of the liquid crystal display panel 1 and the light-emitting surface 21 of the backlight 2 substantially without a gap. Incidentally, here, the surface contact indicates a contact relation in macroscopic view, and a structure in microscopic view, for example, minute surface concaves and convexes due to surface roughness or minute mechanical structures formed on a surface of an optical sheet such as a prism sheet are not considered. The material of the transparent support member 4 is not particularly limited, and glass or transparent resin such as PMMA (Poly Methyl Methacrylate) may be used.

Although the frame 5 is not necessarily an inevitable member, the frame is provided in order to protect the outer peripheral part of the liquid crystal display panel 1 or to prevent separation between the liquid crystal display panel 1 and the backlight 2. Various methods may be used as a fixing method of the frame 5. For example, the frame may be bonded to the outer peripheral part of the front surface of the liquid crystal display panel 1 or may be fixed to the backlight case 20 of the backlight 2 by bonding or screwing.

FIG. 2 is a schematic sectional view of the liquid crystal display device 100 along line II-II of FIG. 1. Incidentally, FIG. 2 shows a state where the liquid crystal display device 100 is assembled.

In the backlight 2, a reflecting sheet 24, a light guide plate 25 and an optical sheet group 26 are housed in this order from the back surface side so as not to drop down to the inside of the backlight case 20. An LED 28 mounted on an LED substrate 27 is disposed so as to face an end face of one side of the light guide plate 25. A light beam irradiated from the LED 28 is introduced into the light guide plate 25, and is propagated to the whole area of the light guide plate 25 while total reflection is repeated between the front surface and the back surface. Besides, a suitable scattering structure, for example, a specified printed pattern of scattering ink is provided on the front surface or the back surface of the light guide plate 25. The reflection direction of the light beam is changed by the scattering structure, and the light beam is extracted toward the front surface side of the light guide plate 25. The reflecting sheet 24 is for again reflecting the light beam, which outgoes from the back surface of the light guide plate 25, toward the light guide plate 25. The optical sheet group 26 is provided so that illumination obtained by the backlight 2 becomes uniform and the brightness thereof becomes high, and may include, for example, a diffusion film or a prism sheet. Here, the front surface of the optical sheet group 26 is the light-emitting surface 21 of FIG. 1. Besides, the rectangular frame-shaped front surface of the backlight case 20 is the convex part 22 of FIG. 1. Incidentally, the structure of the backlight 2 described here is an example, and no limitation is made to this.

As is apparent from the drawing, the thickness of the transparent support member 4 is substantially equal to the sum of the thickness of the front surface part of the backlight case 20 (that is, the distance between the light emitting surface 21 and the front surface of the backlight case 20) and the thickness of the adhesive member 3. By this, the whole surface of the transparent support member 4 is in surface contact with each of the back surface of the liquid crystal display panel 1 and the light-emitting surface 21 of the backlight 2. By this structure, the liquid crystal display panel 1 is not warped toward the back surface side, and a foreign material does not intrude between the liquid crystal display panel 1 and the backlight 2.

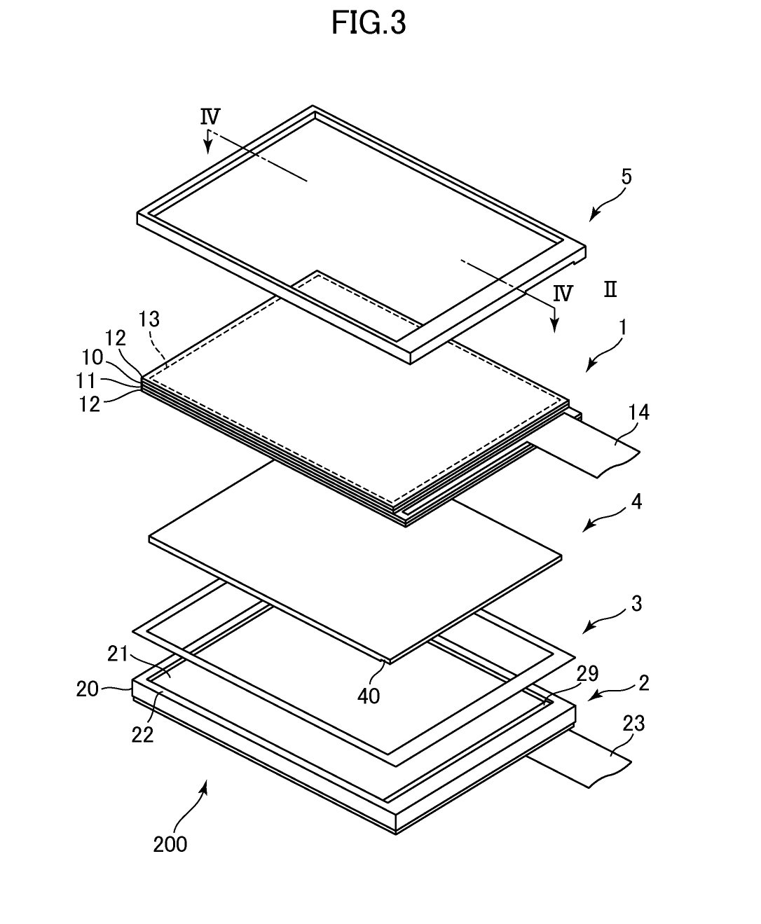

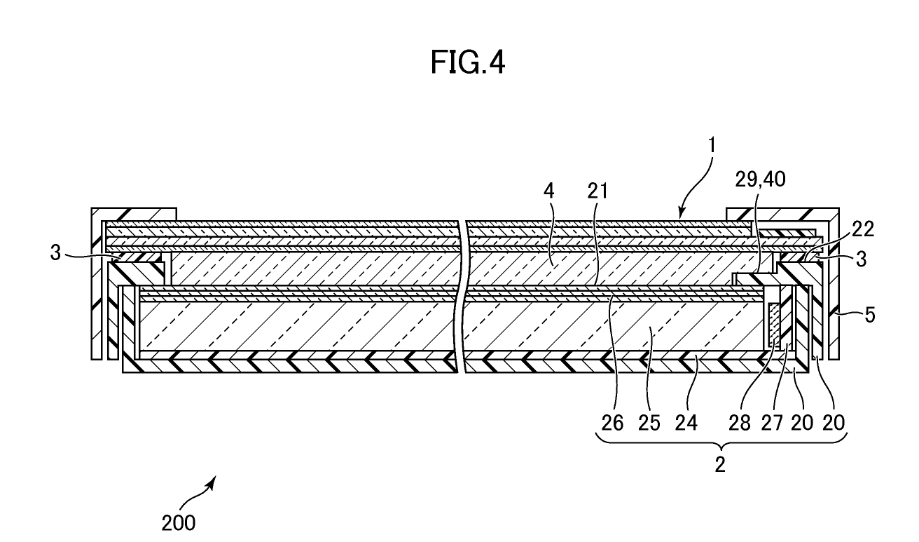

Next, a second embodiment of the invention will be described with reference to FIG. 3 and FIG. 4. A liquid crystal display device 200 of this embodiment is different from that of the first embodiment in the shape of a portion of a convex part 22 of a backlight 2 and the shape of a transparent support member 4 which is slightly changed correspondingly to that. Since other components are the same as those of the first embodiment, the common portions are denoted by the same reference numerals and the duplicate description will be omitted.

FIG. 3 is an exploded perspective view of the liquid crystal display device 200 of the second embodiment of the invention. In the liquid crystal display device 200, the convex part 22 as the front surface of the backlight case 20 of the backlight 2 has a rectangular shape, and a step 29 is provided on one side thereof. That is, a stair-like step is formed on a portion of the convex part 22. Correspondingly to this, a portion of an adhesive member 3 corresponding to a side on which the step 29 is provided is formed to be thin as compared with that of the first embodiment, so that the adhesive member has a shape corresponding to a surface of the convex part 22 positioned at the most front surface side. Besides, similarly, with respect to the transparent support member 4, a step 40 having a complementary shape to that of the step 29 is formed on one side of an end thereof.

FIG. 4 is a schematic sectional view of the liquid crystal display device 200 along line IV-IV of FIG. 3. Incidentally, similarly to FIG. 2, FIG. 4 shows the liquid crystal display device 200 in the assembled state. As shown in the drawing, the step 40 of the transparent support member 4 and the step 29 of the backlight case 20 are interlocked, and this reduces rattling of the transparent support member 4 and prevents light leakage and uneven brightness due to reflection of a light beam or the like by formation of an unnecessary space. Incidentally, the height of the step 40 of the transparent support member 4 is selected so as not to prevent the surface contact between the transparent support member 4 and the liquid crystal display panel 1 and between the transparent support member 4 and the backlight 2. That is, the step 29 and the step 40 are not necessarily required to be in contact with each other, and a slight gap may exist between both.

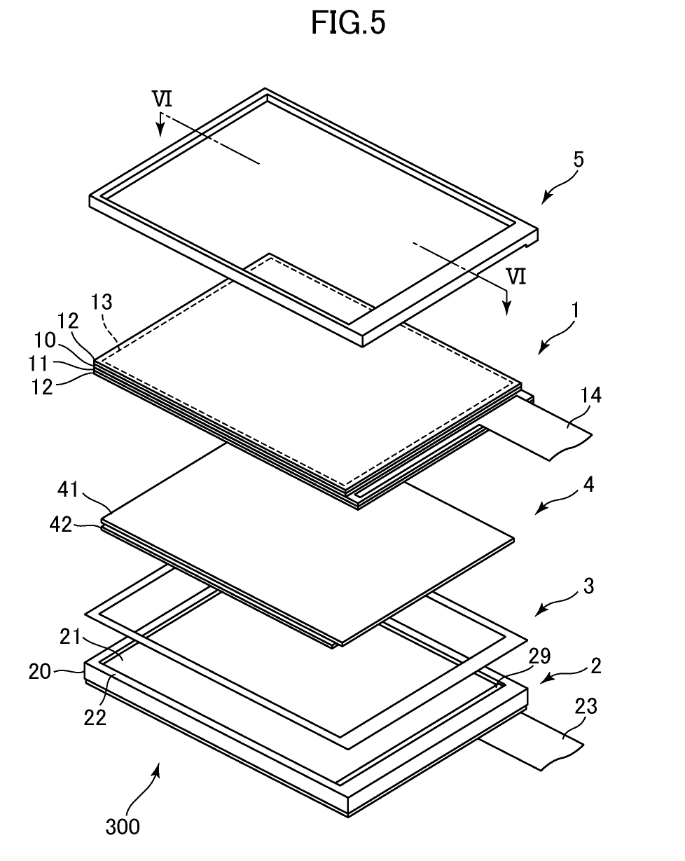

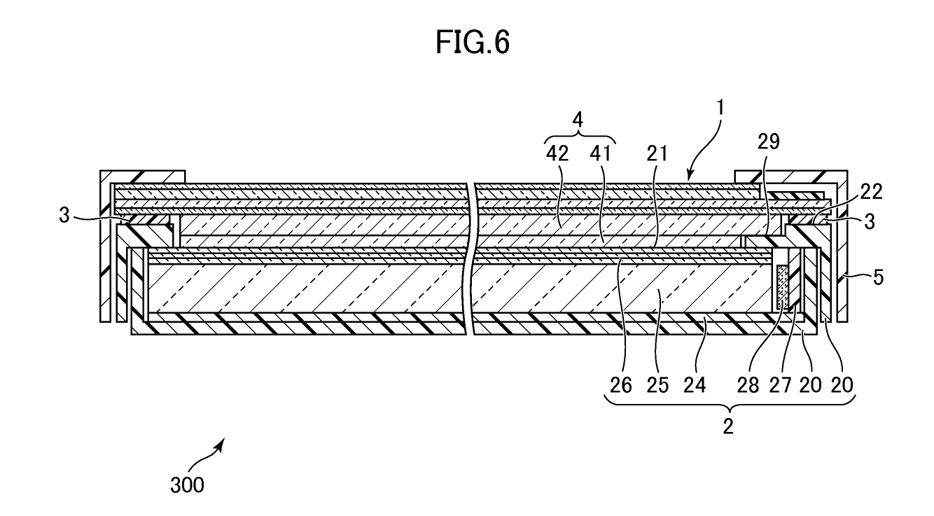

Next, a third embodiment of the invention will be described with reference to FIG. 5 and FIG. 6. A liquid crystal display device 300 of this embodiment is different from that of the second embodiment only in the structure of a transparent support member 4. Since other components are the same as those of the second embodiment, the common portions are denoted by the same reference numerals and the duplicate description will be omitted.

FIG. 5 is an exploded perspective view of the liquid crystal display device 300 of the third embodiment. In the liquid crystal display device 300, a laminate of plural plate-like members different in size is used as the transparent support member 4 instead of forming a step at an end of the transparent support member 4. In the example shown in FIG. 5, a first transparent support member 41 and a second transparent support member 42, which are two plate-like members, are laminated so that the transparent support member 4 is obtained.

The length of the second transparent support member 42 in one direction (here, in along axis direction) is slightly shorter than that of the first transparent support member 41. By this, when the first transparent support member 41 and the second transparent support member 42 are laminated, the same shape as the step 40 of the second embodiment is obtained. Incidentally, the first transparent support member 41 and the second transparent support member 42 are merely overlapped and arranged, and both are not required to be bonded. However, these members may be bonded.

FIG. 6 is a schematic sectional view of the liquid crystal display device 300 along line VI-VI of FIG. 5. Incidentally, similarly to FIG. 2 and FIG. 4, FIG. 6 also shows the liquid crystal display device 300 in the assembled state. As is clearly shown in the drawing, the first transparent support member 41 and the second transparent support member 42 are laminated, and a difference in level at the end caused by the difference in size is interlocked with a step 29 of a backlight case 20. Also in such a structure, the rattling of the transparent support member 4 is reduced, and the light leakage and uneven brightness due to the reflection of a light beam or the like caused by the formation of an unnecessary space can be prevented.

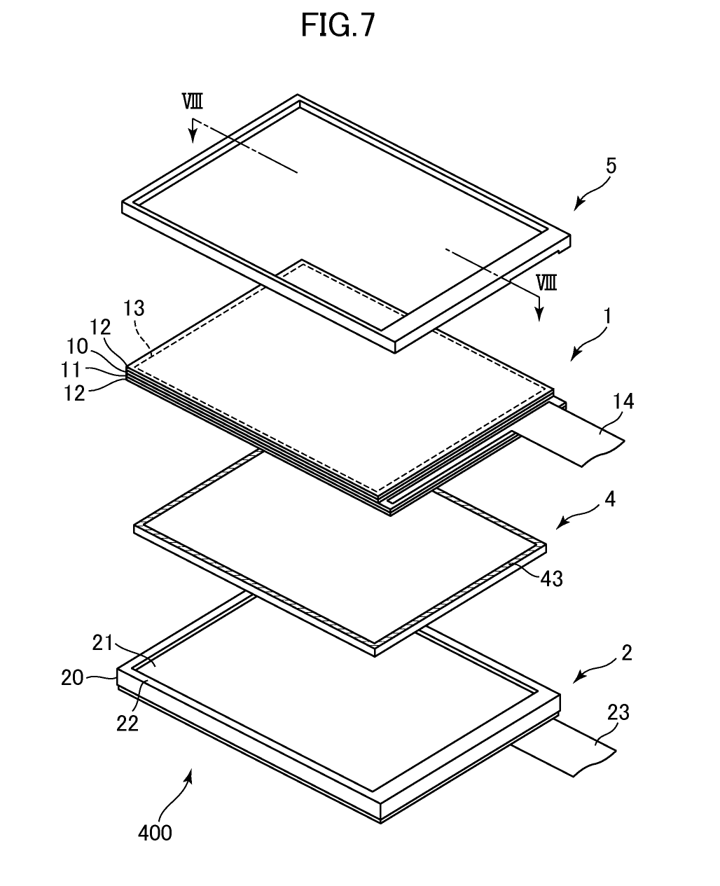

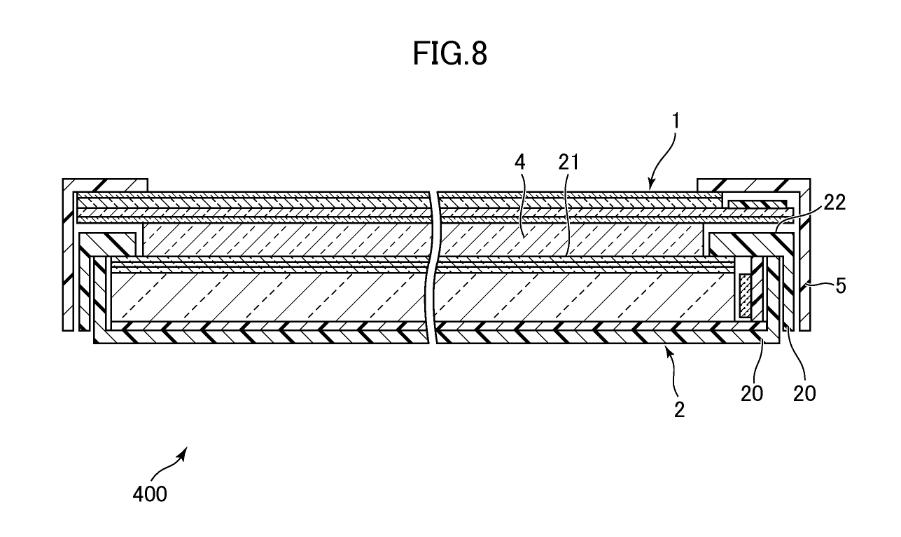

Next, a fourth embodiment of the invention will be described with reference to FIG. 7 and FIG. 8. A liquid crystal display device 400 of this embodiment is the same as that of the first embodiment except that the adhesive member 3 is omitted, and a structure of a transparent support member 4 is slightly different. Also in this embodiment, common portions to those of the first embodiment are denoted by the same reference numerals and the duplicate description will be omitted.

In this embodiment, an adhesive force to a liquid crystal display panel 1 and a backlight 2 is given to the transparent support member 4 itself, so that an adhesive member is not required. A method of giving the adhesive force to the transparent support member 4 is not particularly limited. For example, a transparent adhesive having high transmittance, such as a silicone adhesive, is applied to both surfaces of the transparent support member 4, and the transparent support member may be bonded to each of the liquid crystal display panel 1 and the backlight 2. The transparent support member 4 may be fixed to each of the liquid crystal display panel and the backlight 2 by another method, for example, by attraction caused by electrostatic force or inter-molecular force.

Besides, as shown in FIG. 7, it is preferable that a light-shielding area 43 having a light-shielding property is formed on an outer peripheral part so as to surround the transparent support member 4. This is for preventing that a light beam from the backlight 2 is leaked to the outside of an image forming area 13 since there is no adhesive member. Although a method of forming the light-shielding area 43 is not limited, the area maybe formed by applying a black or deep color paint or by evaporating a suitable material such as chromium.

Alternately, an adhesive colored in black or deep color is used, and the transparent support member 4 may be bonded to each of the liquid crystal display panel and the backlight 2 only in the light-shielding area 43.

FIG. 8 is a schematic sectional view of the liquid crystal display device 400 along line VIII-VIII of FIG. 7. Incidentally, similarly to FIG. 2, FIG. 4 and FIG. 6, FIG. 8 also shows the liquid crystal display device 400 in the assembled state. In this embodiment, the thickness of the transparent support member 4 may be the thickness of the front surface portion of the backlight case 20 (that is, the distance between the light-emitting surface 21 and the front surface of the backlight case 20). Thus, as compared with the liquid crystal display device of the first to third embodiments, the thickness of the whole liquid crystal display device 400 can be made thin. Besides, since an adhesive member is not provided on the front surface of the convex part 22, margin for adhesion is not required. Accordingly, a frame can be narrowed by decreasing the width of the convex part 22. Further, a process of accurately bonding the adhesive member to the front surface of the convex part 22 is not required, and there is a merit that the process cost is reduced.

The forms, arrangement, number and the like of the respective members indicated in the embodiments explained above are mere examples and the invention is not limited to them. When the invention is implemented, those skilled in the art can arbitrary design and modify the forms and the like of the members according the implementation.

While there have been described what are at present considered to be certain embodiments of the invention, it will be understood that various modifications maybe made thereto, and it is intended that the appended claims cover all such modifications as fall within the true spirit and scope of the invention.

What is claimed is:

1. A liquid crystal display device comprising:
a liquid crystal display panel including an image forming area where pixels are arranged and an image is formed;
a backlight which is a flat light source; and
a transparent support member which is disposed between the liquid crystal display panel and the backlight and is in surface contact with the liquid crystal display panel and the backlight over an entire area of the image forming area.

2. The liquid crystal display device according to claim 1, wherein the transparent support member includes a plurality of laminated plate-like members different in size.

3. The liquid crystal display device according to claim 1, wherein the transparent support member includes a step at an end.

4. The liquid crystal display device according to claim 1, wherein the transparent support member is bonded to the liquid crystal display panel and the backlight.

5. The liquid crystal display device according to claim 1, wherein an outer peripheral part of the transparent support member has a light-shielding property.
